(19) United States
(12) Patent Application Publication
(10) Pub. No.: US 2005/0076367 A1
(43) Pub. Date: Apr. 7, 2005

(54) System and method for creating user profiles

(76) Inventors: Carolynn Rae Johnson, Indianapolis, IN (US); Marc Aaron Kiefer, Indianapolis, IN (US); Darrel Wayne Randall, Danville, IN (US)

Correspondence Address: Joseph S Tripoli;Thomson Multimedia Licensing Inc, PO Box 5312, Princeton, NJ, 08543-5312, US

(21) Appl. No.: 10/468,561

(22) PCT Filed: Feb. 28, 2002
(86) PCT No.: PCT/US02/06241

Related U.S. Application Data
(60) Provisional application No. 60/272,176, filed on Feb. 28, 2001.

(51) Int. Cl. H04N 5/445; G06F 3/00; H04N 7/16; G06F 13/00

(52) U.S. Cl. 725/58; 725/28; 725/46

(57) ABSTRACT

A system and method for creating user profiles in a television system are described. The system comprises a storage medium having storage locations to store user profiles for a plurality of users; a user interface for creating new user profiles having fields for data entry to be stored in the storage medium; the user interface for creating new user profiles comprising a user option to select and copy data from a stored user profile; and means to select a stored user profile, copy selected data from the stored user profile to corresponding fields in the new user profile, and save the new user profile at a storage location.

### FIELD OF THE INVENTION

This invention relates to the field of video processing in general and, in particular, to a system and method for creating user profiles.

### BACKGROUND OF THE INVENTION

Due to the advent of cable television, direct satellite systems, and other television program broadcast systems, television viewers have very large numbers of programs from which to select. Many of these systems utilize Electronic Program Guide (EPG) systems, including their hardware, software, and downloading and storage capabilities. An EPG is an interactive, on screen equivalent to TV listings found in local newspapers or other print media. An EPG can provide up to 20 different kinds of information about each program that is within the time frame covered by the EPG. In a typical EPG systern, an electronic host device stores records corresponding to upcoming television programs that are within the EPG's time frame. Each record contains program identification data that is unique to a particular upcoming television program. The program identification data can include program title, start time, end time, duration, rating, time remaining, content, cost, topic, theme, actors, writer, production studio, awards, keywords, release date, director, and a brief description. The records are updated periodically by both deleting records of programs that have previously aired and adding new records of upcoming programs that fall within the EPG's time frame as time passes.

U.S. Pat. No. 5,515,106, Chaney, describes a data packet structure necessary to implement an EPG system. The data packet structure is designed so that both the channel information (e.g., channel name, call letters, channel number, type, etc.) and the program identification information (e.g., content, title, rating, star, duration, cost, etc.) relating to a program may be transmitted from a program guide database provider to a receiving apparatus such as a television efficiently.

Many of the current systems allow users of the systems to set-up a plurality of user profiles so that a plurality of system or program parameters may be automatically configured for each user. Some of the user profile parameters may include, for example, favorite channel list, language setting, video and sound setting, pay-per-view control, and parental control, etc., for each user. For example, under each user profile, parental control may further include the ability for a user to select: (1) how much time a specific viewer is allowed to watch TV on weekdays or weekends; (2) how much money a specific viewer can spend on pay-per view programming per program or per month; (3) whether a specific viewer should have access to a specific channel; and (4) the hours during which a specific viewer can access satellite programming for weekends or weekdays.

However, setting up new user profiles using existing methods and systems can be a time consuming process. In existing systems, if a system owner (i.e., the parent) chooses to set up a new profile, he or she will have to select a multitude of parameters, which may include: establishing movie rating limits, TV rating limits, limits for D S L V FV content; determining whether or not to permit viewing of programs that have not been rated for content; establishing a per-event spending limit and a monthly spending limit; establishing a maximum number of viewable hours for weekends and weekdays; establishing hours during which satellite programming can be viewed for weekends and weekdays; and establishing channel lists which determines whether to block or allow access to specific channels (which may be over 200 channels).

### SUMMARY OF THE INVENTION

The present inventors recognize that because of the amount of fields currently available for user profile including parameters for parental control, setting up a new user profile can be cumbersome and take a considerable amount of time. Moreover, this problem is intensified by the fact that if the system owner wishes to create a second user profile, he or she must repeat the whole procedure over again, even if the second user profile is substantially similar to the first profile that was created and stored.

Attempts have been made to reduce the setup time for creating user profiles, such as allowing the user to select an option to eliminate all unsubscribed channels from the profile channel list. However, this does not reduce the setup time for the remaining limits, and the system owner must still block or allow access to each of the subscribed channels that remain in the channel list after completion of this process. This feature actually does very little to reduce the lengthy setup required for each profile.

These problems and other are solved by the present invention which in one aspect is an apparatus for use in a video apparatus, the apparatus comprising a storage medium having storage locations to store user profiles for entertainment system users; a user interface for creating new user profiles having fields for data entry to be stored in the storage medium; the user interface for creating new user profiles comprising a user option to select and copy data from a stored user profile; and means to select a stored user profile, copy selected data from the stored user profile to corresponding fields in the new user profile, and save the new user profile at a storage location.

Preferably, the data that is copied from the selected stored user profile to the fields of the user interface can be edited. It is also preferable that the stored user profiles comprise data relating to user identification and one or more of television program rating limits, channel lists, spending limits, viewing hours, and parent or child status. Moreover, the user interface can comprise a television screen display and an input module for selecting options presented in the screen display and for entering alphanumeric data in the fields.

The user interface can comprise means for entering data in the fields and making selections. Preferably, the means to select a stored user profile, copy selected data from the stored user profile to corresponding fields in the new user profile, and save the new user profile at a storage location comprises a processor agent. Also preferably, the user profiles are stored in a non-volatile memory.

It is preferred that the means to select a stored user profile, copy selected data from the stored user profile to corresponding fields in the new user profile, and save the new user profile at a storage location comprises a processor agent, the user profiles are stored in non-volatile memory, wherein the user interface comprises a television screen display and an input module for selecting options presented in the screen display and for entering alphanumeric data in the fields, and the user profiles comprising user identification and one or more of television program rating limits, channel lists, spending limits, viewing hours, and parent or child status.

In another embodiment, the invention is a television apparatus having a parental control system having a user profile creation apparatus comprising a storage medium having storage locations to store user profiles for entertainment system users; a user interface for creating new user profiles having fields for data entry to be stored in the storage medium; the user interface for creating new user profiles comprising a user option to select and copy data from a stored user profile; and means to select a stored user profile, copy selected data from the stored user profile to corresponding fields in the new user profile, and save the new user profile at a storage location.

In yet another embodiment, the invention is a method for creating new user profiles in an entertainment apparatus comprising displaying a new user profile interface having means to access a list of stored user profiles, the user profiles comprising data arranged in fields, selecting a stored user profile, and copying data from fields of the selected user profile to corresponding fields of the new user profile interface.

Preferably, the fields comprise user identification and one or more of television program rating limits, channel lists, spending limits, viewing hours, and parent or child status.

It is also preferable that the method of the present invention further comprise the step of saving the new user profile in a non-volatile memory. The method of the present invention also preferably comprises the further step of editing the data copied into the fields of the new user profile interface.

Finally, it is preferable that the method of the present invention comprise selecting a stored user profile from a non-volatile memory, copying non-volatile memory settings of the selected stored user profile to corresponding local variables of the new user profiles, editing the local variables, and saving the local variables to the non-volatile memory as a new user profile.

### BRIEF DESCRIPTION OF THE DRAWINGS

FIG. 1 is a schematic of an apparatus capable of processing user commands and displaying user interface screens in accordance with the present invention.

FIG. 2 is a schematic of a digital video processing apparatus suitable for processing user commands and displaying user interface screens in accordance with the present invention.

FIG. 3 is a schematic of a specific implementation of the apparatus generally shown in FIG. 2.

FIG. 4 is a display module having a diagrammatic representation of a user interface for creating a new user profile according to the present invention.

FIG. 5 is a flow chart of a method of creating a new user profile according to the present invention.

### DETAIL OF THE INVENTION

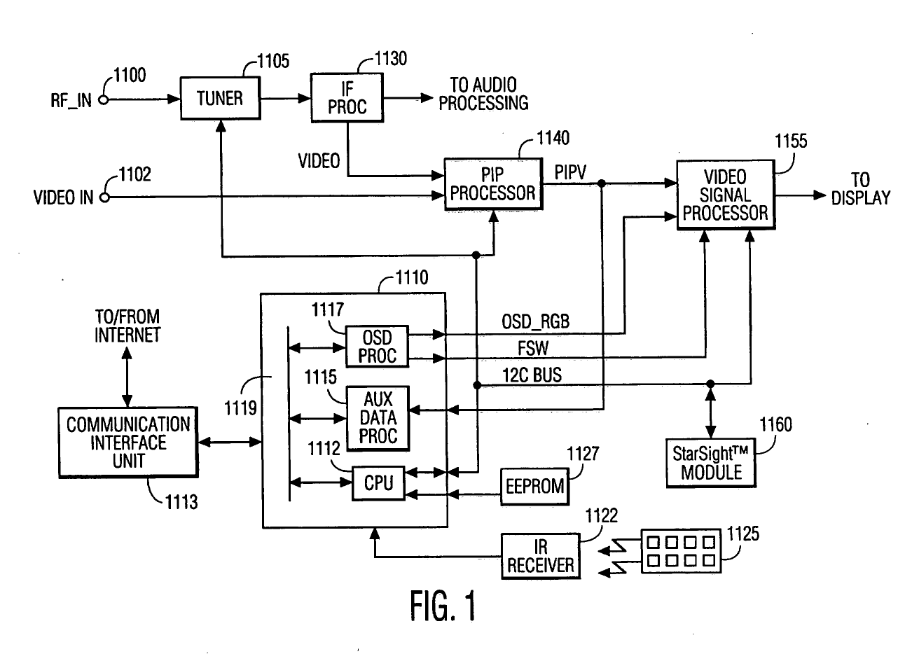

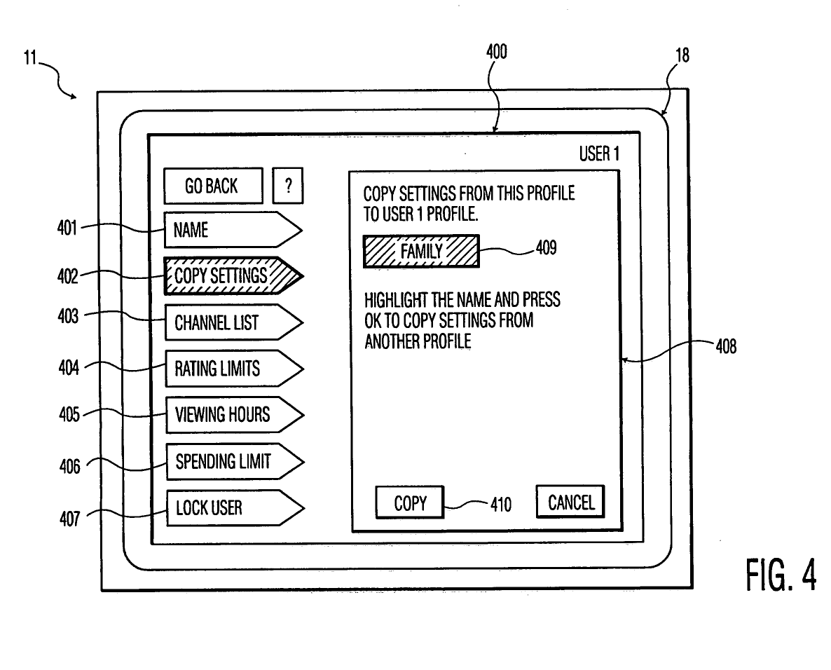

FIG. 1 is a schematic of an apparatus capable of processing user commands, displaying the user interface screens of FIG. 4, and performing searches of stored program guide records in accordance with the present invention. The apparatus is capable of processing both analog NTSC television signals and internet information. The apparatus of FIG. 1 has a first input 1100 for receiving television signal RF_IN at RF frequencies and a second input 1102 for receiving baseband television signal VIDEO IN. Signal RF_IN may be supplied from a source such as an antenna or cable system while signal VIDEO IN may be supplied, for example, by a video cassette recorder (VCR). Tuner 1105 and IF processor 1130 operates in a conventional manner for tuning and demodulating a particular television signal that is included in signal RF_IN. IF processor 1130 produces baseband video signal VIDEO representing the video program portion of the tuned television signal. IF processor 1130 also produces a baseband audio signal that is coupled to an audio processing section (not shown in FIG. 1) for further audio processing. Although FIG. 1 shows input 1102 as a baseband signal, the television receiver could include a second tuner and IF processor similar to units 1105 and 1130 for producing a second baseband video signal from either signal RF_IN or from a second RF signal source.

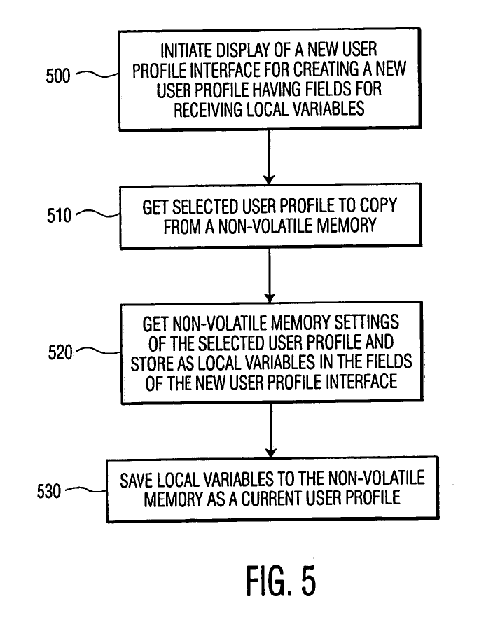

The system shown in FIG. 1 also includes a main microprocessor (mP) 1110 for controlling components of the television receiver such as tuner 1105, picture-in-picture processing unit 1140, video signal processor 1155, and StarSight™, data processing module 1160. As used herein, the term “microprocessor” represents various devices including, but not limited to, microprocessors, microcomputers, microcontrollers and controllers. Microprocessor 1110 controls the system by sending and receiving both commands and data via serial data bus I²C BUS which utilizes the well-known 1²C serial data bus protocol. More specifically, central processing unit (CPU) 1112 within mP 1110 executes control programs contained within memory, such as EEPROM 1127 shown in FIG. 1, in response to commands provided by a user, e.g., via IR remote control 1125 and IR receiver 1122. For example, activation of a “CHANNEL UP” feature on remote control 1125 causes CPU 1112 to send a “change channel” command along with channel data to tuner 1105 via I²C BUS. As a result, tuner 1105 tunes the next channel in the channel scan list. Another example of a control program stored in EEPROM 1127 is software for implementing the operations shown in FIGS. 4 and 5 (in flow chart form) in accordance with the present invention as to be described below.

Main microprocessor 1110 also controls the operation of a communications interface unit 1113 for providing the capability to upload and download information to and from the internet. Communication interface unit 1113 includes, for example, a modem for connecting to an internet service provider, e.g., via a telephone line or via a cable television line. The communication capability allows the system shown in FIG. 1 to provide email capability and internet-related features such as web browsing in addition to receiving television programming.

CPU 1112 controls functions included within mP 1110 via bus 1119 within mP 1110. In particular, CPU 1112 controls auxiliary data processor 1115 and on-screen display (OSD) processor 1117. Auxiliary data processor 1115 extracts auxiliary data such as StarSight™ data from video signal PIPV.

StarSight™ data which provides program guide data information in a known format is typically received only on a particular television channel and the television receiver must tune that channel to extract StarSight™. data. To prevent StarSight™ data extraction from interfering with normal use of the television receiver, CPU 1112 initiates StarSight™ data extraction by tuning the particular channel only during a time period when the television receiver is usually not in use (e.g., 2:00 AM). At that time, CPU 1112 configures decoder 1115 such that auxiliary data is extracted from horizontal line intervals such as line 16 that are used for StarSight™ data. CPU 1112 controls the transfer of extracted StarSight™ data from decoder 1115 via I²C BUS to StarSight™ module 1160. A processor internal to the module formats and stores the data in memory within the module. In response to the StarSight™ EPG display being activated (e.g., a user activating a particular key on remote control 125), CPU 1112 transfers formatted StarSight™ EPG display data from StarSight™ module 1160 via I²C BUS to OSD processor 1117.

OSD processor 1117 operates in a conventional manner to produce R, G, and B video signals OSD_RGB that, when coupled to a displayed device (not shown), will produce a displayed image representing on-screen display information in according to FIGS. 4-5 to be described later. OSD processor 1117 also produces control signal Fast-Switch (FSW) which is intended to control a fast switch for inserting signals OSD_RGB into the system's video output signal at times when an on-screen display is to be displayed. Therefore, when a user enables the various user interface screens of the present invention to be described later, OSD processor 1117 produces the corresponding signals OSD_RGB representing the on-screen display information previously stored or programmed in the memory 1127. For example, when a user enables an EPG, e.g., by activating a particular switch on remote control 1125, CPU 1112 enables processor 1117. In response, processor 1117 produces signals OSD_RGB representing the program guide data information previously extracted and already stored in memory, as discussed above. Processor 1117 also produces signal FSW indicating when the EPG is to be displayed.

Video signal processor (VSP) 1155 performs conventional video signal processing functions, such as luma and chroma processing. Output signals produced by VSP 1155 are suitable for coupling to a display device, e.g., a kinescope or LCD device (not shown in FIG. 1), for producing a displayed image. VSP 1155 also includes a fast switch for coupling signals produced by OSD processor 1117 to the output video signal path at times when graphics and/or text is to be included in the displayed image. The fast switch is controlled by control signal FSW which is generated by OSD processor 1117 in main microprocessor 1110 at times when text and/or graphics are to be displayed.

The input signal for VSP 1155 is signal PIPV that is output by picture-in-picture (PIP) processor 1140. When a user activates PIP mode, signal PIPV represents a large picture (large pix) into which a small picture (small pix) is inset. When PIP mode is inactive, signal PIPV represents just the large pix, i.e., no small pix signal is included in signal PIPV. PIP processor 1140 provides the described functionality in a conventional manner using features included in unit 1140 such as a video switch, analog-to-digital converter (ADC), RAM, and digital to analog converter (DAC).

As mentioned above, the display data included in the EPG display is produced by OSD processor 1117 and included in the output signal by VSP 1155 in response to fast switch signal FSW. When controller 1110 detects activation of the EPG display, e.g., when a user presses an appropriate key on remote control 1125, controller 1110 causes OSD processor 1117 to produce the EPG display using information such as program guide data from StarSight™ module 1160. Controller 1110 causes VSP 1155 to combine the EPG display data from OSD processor 1117 and the video image signal in response to signal FSW to produce a display including EPG. The EPG can occupy all or only a portion of the display area.

When the EPG display is active, controller 1110 executes an EPG control program stored in EEPROM 1127. The control program monitors the location of a position indicator, such as a cursor and/or highlighting, in the EPG display. A user controls the location of the position indicator using direction and selection keys of remote control 1125. Alternatively, the system could include a mouse device. Controller 1110 detects activation of a selection device, such as clicking a mouse button, and evaluates current cursor location information in conjunction with EPG data being displayed to determine the function desired, e.g., tuning a particular program. Controller 1110 subsequently activates the control action associated with the selected feature.

The process and displaying of a program guide in accordance with the present invention may be implemented using a combination of software and hardware. For example, referring to FIG. 1, display of an EPG may be implemented by software in memory such as EEPROM 1127. Activation of an EPG, e.g., by a user pressing an EPG related button on remote control 1125, causes CPU 1112 to execute the EPG software routine. As part of generating an EPG display, CPU 1112 also accesses EPG data and graphics that may be stored in StarSightr module 1160 via the 12C bus. Under control of the EPG software routine stored in EEPROM 1127, CPU 1112 enables OSD processor 1117 which formats the EPG data into a form suitable for producing an OSD representing the EPG data and graphics. The OSD data produced by OSD processor 1117 is coupled to video signal processor (VSP) 1155 via signal lines OSD_RGB. A fast switch in VSP 1155 couples in the EPG OSD data to the output of VSP 1155 under control of signal FSW. That is, the software routine being executed by CPU 1112 determines when the EPG data is to be displayed (e.g., what portion of the display) and sets signal FSW to the appropriate state for causing the fast switch to couple the EPG data to the output.

An exemplary embodiment of the features of the system shown in FIG. 1 that have been described thus far comprises an ST9296 microprocessor produced by SGS-Thomson Microelectronics for providing the features associated with mP 1110; an M65616 picture-in-picture processor produced by Mitsubishi for providing the described basic PIP functionality associated with PIP processor 1140; and an LA7612 video signal processor produced by Sanyo for providing the functions of VSP 1155.

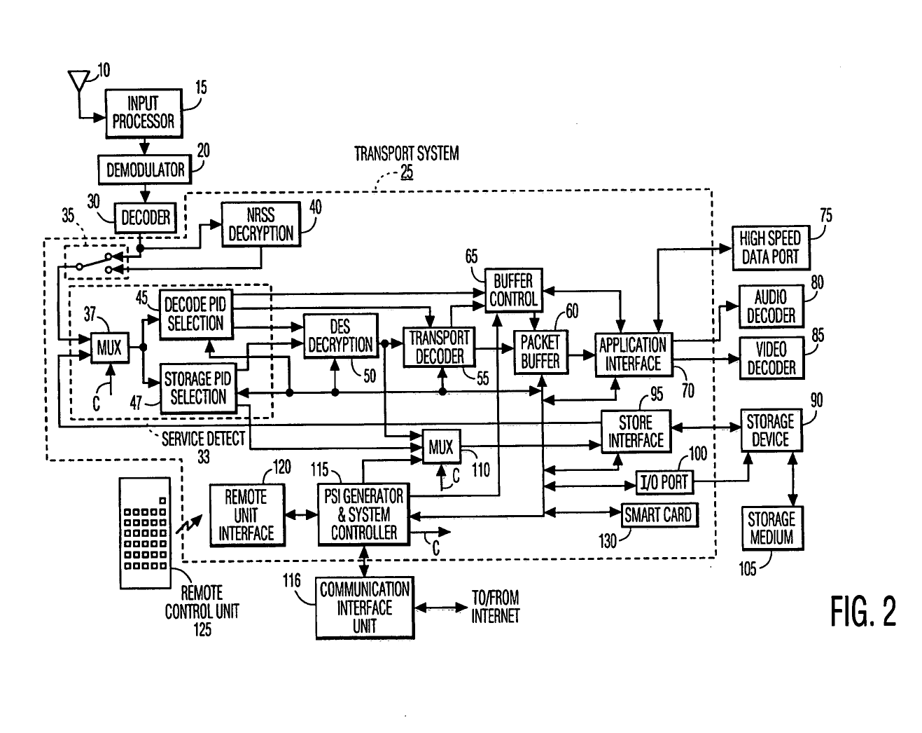

FIG. 2 shows another example of an apparatus capable of processing user commands, displaying the user interface screens of FIG. 4, and performing searches of stored program guide records in accordance with the present invention. As described below, the apparatus shown in FIG. 2 is an MPEG compatible system for receiving MPEG encoded transport streams representing broadcast programs. However, the system shown in FIG. 2 is exemplary only. The user interface system described herein is also applicable to other types of digital signal processing devices including non-MPEG compatible systems, involving other types of encoded datastreams. For example, other devices include digital video disc (DVD) systems and MPEG program streams, and systems combining computer and television functions such as the so-called “PCTV.” Further, although the system described below is described as processing broadcast programs, this is exemplary only. The term “program” is used to represent any form of packetized data such as telephone messages, computer programs, internet data or other communications, for example.

In overview, in the video receiver system of FIG. 2, a carrier modulated with video data is received by antenna 10 and processed by unit 15. The resultant digital output signal is demodulated by demodulator 20 and decoded by decoder 30. The output from decoder 30 is processed by transport system 25 which is responsive to commands from remote control unit 125. System 25 provides compressed data outputs for storage, further decoding, or communication to other devices.

Video and audio decoders 85 and 80 respectively, decode the compressed data from system 25 to provide outputs for display. Data port 75 provides an interface for communication of the compressed data from system 25 to other devices such as a computer or High Definition Television (HDTV) receiver, for example. Storage device 90 stores the compressed data from system 25 on storage medium 105. Device 90, in a playback mode also supports retrieval of the compressed data from storage medium 105 for processing by system 25 for decoding, communication to other devices or storage on a different storage medium (not shown to simplify drawing).

In FIG. 2, a carrier modulated with video data received by antenna 10, is converted to digital form and processed by input processor 15. Processor 15 includes radio frequency (RF) tuner and intermediate frequency (IF) mixer and amplification stages for down-converting the input video signal to a lower frequency band suitable for further processing. The resultant digital output signal is demodulated by demodulator 20 and decoded by decoder 30. The output from decoder 30 is further processed by transport system 25.

Multiplexer (mux) 37 of service detector 33 is provided, via selector 35, with either the output from decoder 30, or the decoder 30 output further processed by a descrambling unit 40. Descrambling unit 40 may be, for example, a removable unit such as a smart card in accordance with ISO 7816 and NRSS (National Renewable Security Standards) Committee standards (the NRSS removable conditional access system is defined in EIA Draft Document IS-679, Project PN-3639). Selector 35 detects the presence of an insertable, compatible, descrambling card and provides the output of unit 40 to mux 37 only if the card is currently inserted in the video receiver unit. Otherwise selector 35 provides the output from decoder 30 to mux 37. The presence of the insertable card permits unit 40 to descramble additional premium program channels, for example, and provide additional program services to a viewer. It should be noted that in the preferred embodiment NRSS unit 40 and smart card unit 130 (smart card unit 130 is discussed later) share the same system 25 interface such that only either an NRSS card or a smart card may be inserted at any one time. However, the interfaces may also be separate to allow parallel operation.

The data provided to mux 37 from selector 35 is in the form of an MPEG compliant packetized transport datastream as defined in MPEG systems standard section 2.4 and includes program guide information and the data content of one or more program channels. The individual packets that comprise particular program channels are identified by Packet Identifiers (PIDs). The transport stream contains Program Specific Information (PSI) for use in identifying the PIDs and assembling individual data packets to recover the content of all the program channels that comprise the packetized datastream. Transport system 25, under the control of the system controller 115, acquires and collates program guide information from the input transport stream, storage device 90 or an internet service provider via the communication interface unit 116. The individual packets that comprise either particular program channel content or Program Guide information, are identified by their Packet Identifiers (PIDs) contained within header information. As discussed above, the program description contained in the program guide information may comprise different program descriptive fields such as title, star, rating, etc., relating to a program.

The user interface incorporated in the video receiver shown in FIG. 2 enables a user to activate various features by selecting a desired feature from an on-screen display (OSD) menu. The OSD menu may include an electronic program guide (EPG) as described above, and other features discussed below.

Data representing information displayed in the OSD menu is generated by system controller 115 in response to stored on-screen display (OSD) information representing text/graphics, stored program guide information, and/or program guide and text/graphics information received via the input signal as described above and in accordance with exemplary control programs to be shown in FIGS. 4-5, and to be discussed below. The software control programs may be stored, for example, in embedded memory (not shown) of system controller 115.

Using remote control unit 125 (or other selection means such as a mouse) a user can select from the OSD menu items such as a program to be viewed, a program to be stored (e.g., recorded), the type of storage media and manner of storage. System controller 115 uses the selection information, provided via interface 120, to configure system 25 to select the programs for storage and display and to generate PSI suitable for the selected storage device and media. Controller 115 configures system 25 elements 45, 47, 50, 55, 65 and 95 by setting control register values within these elements via a data bus and by selecting signal paths via muxes 37 and 110 with control signal C.

In response to control signal C, mux 37 selects either, the transport stream from unit 35, or in a playback mode, a datastream retrieved from storage device 90 via store interface 95. In normal, non-playback operation, the data packets comprising the program that the user selected to view are identified by their PIDs by selection unit 45. If an encryption indicator in the header data of the selected program packets indicates the packets are encrypted, unit 45 provides the packets to decryption unit 50. Otherwise unit 45 provides non-encrypted packets to transport decoder 55. Similarly, the data packets comprising the programs that the user selected for storage are identified by their PIDs by selection unit 47. Unit 47 provides encrypted packets to decryption unit 50 or non-encrypted packets to mux 110 based on the packet header encryption indicator information.

The functions of decryptors 40 and 50 may be implemented in a single removable smart card which is compatible with the NRSS standard. The approach places all security related functions in a removable unit that can easily be replaced if a service provider decides to change encryption techniques or to permit easily changing the security system, e.g., to descramble a different service.

Units 45 and 47 employ PID detection filters that match the PIDs of incoming packets provided by mux 37 with PID values pre-loaded in control registers within units 45 and 47 by controller 115. The pre-loaded PIDs are used in units 47 and 45 to identify the data packets that are to be stored and the data packets that are to be decoded for use in providing a video image. The pre-loaded PIDs are stored in look-up tables in units 45 and 47. The PID look-up tables are memory mapped to encryption key tables in units 45 and 47 that associate encryption keys with each pre-loaded PID. The memory mapped PID and encryption key look-up tables permit units 45 and 47 to match encrypted packets containing a pre-loaded PID with associated encryption keys that permit their decryption. Non-encrypted packets do not have associated encryption keys. Units 45 and 47 provide both identified packets and their associated encryption keys to decryptor 50. The PID look-up table in unit 45 is also memory mapped to a destination table that matches packets containing pre-loaded PIDs with corresponding destination buffer locations in packet buffer 60. The encryption keys and destination buffer location addresses associated with the programs selected by a user for viewing or storage are pre-loaded into units 45 and 47 along with the assigned PIDs by controller 115. The encryption keys are generated by ISO 7816-3 compliant smart card system 130 from encryption codes extracted from the input datastream. The generation of the encryption keys is subject to customer entitlement determined from coded information in the input data stream and/or pre-stored on the insertable smart card itself (International Standards Organization document ISO 7816-3 of 1989 defines the interface and signal structures for a smart card system).

The packets provided by units 45 and 47 to unit 50 are encrypted using an encryption technique such as the Data Encryption Standard (DES) defined in Federal Information Standards (FIPS) Publications 46, 74 and 81 provided by the National Technical Information Service, Department of Commerce. Unit 50 decrypts the encrypted packets using corresponding encryption keys provided by units 45 and 47 by applying decryption techniques appropriate for the selected encryption algorithm. The decrypted packets from unit 50 and the non-encrypted packets from unit 45 that comprise the program for display are provided to decoder 55. The decrypted packets from unit 50 and the non-encrypted packets from unit 47 that comprise the program for storage are provided to mux 110.

Unit 60 contains four packet buffers accessible by controller 115. One of the buffers is assigned to hold data destined for use by controller 115 and the other three buffers are assigned to hold packets that are destined for use by application devices 75, 80 and 85. Access to the packets stored in the four buffers within unit 60 by both controller 115 and by application interface 70 is controlled by buffer control unit 65. Unit 45 provides a destination flag to unit 65 for each packet identified by unit 45 for decoding. The flags indicate the individual unit 60 destination locations for the identified packets and are stored by control unit 65 in an internal memory table. Control unit 65 determines a series of read and write pointers associated with packets stored in buffer 60 based on the First-In-First-Out (FIFO) principle. The write pointers in conjunction with the destination flags permit sequential storage of an identified packet from units 45 or 50 in the next empty location within the appropriate destination buffer in unit 60. The read pointers permit sequential reading of packets from the appropriate unit 60 destination buffers by controller 115 and application interface 70.

The non-encrypted and decrypted packets provided by units 45 and 50 to decoder 55 contain a transport header as defined by section 2.4.3.2 of the MPEG systems standard. Decoder 55 determines from the transport header whether the non-encrypted and decrypted packets contain an adaptation field (per the MPEG systems standard). The adaptation field contains timing information including, for example, Program Clock References. (PCRs) that permit synchronization and decoding of content packets. Upon detection of a timing information packet, that is a packet containing an adaptation field, decoder 55 signals controller 115, via an interrupt mechanism by setting a system interrupt, that the packet has been received. In addition, decoder 55 changes the timing packet destination flag in unit 65 and provides the packet to unit 60. By changing the unit 65 destination flag, unit 65 diverts the timing information packet provided by decoder 55 to the unit 60 buffer location assigned to hold data for use by controller 115, instead of an application buffer location.

Upon receiving the system interrupt set by decoder 55, controller 115 reads the timing information and PCR value and stores it in internal memory. PCR values of successive timing information packets are used by controller 115 to adjust the system 25 master clock (27 MHz). The difference between PCR based and master clock based estimates of the time interval between the receipt of successive timing packets, generated by controller 115, is used to adjust the system 25 master clock. Controller 115 achieves this by applying the derived time estimate difference to adjust the input control voltage of a voltage controlled oscillator used to generate the master clock. Controller 115 resets the system interrupt after storing the timing information in internal memory.

Packets received by decoder 55 from units 45 and 50 that contain program content including audio, video, caption, and other information, are directed by unit 65 from decoder 55 to the designated application device buffers in packet buffer 60. Application control unit 70 sequentially retrieves the audio, video, caption and other data from the designated buffers in buffer 60 and provides the data to corresponding application devices 75, 80 and 85. The application devices comprise audio and video decoders 80 and 85 and high speed data port 75. For example, packet data corresponding to a composite program guide generated by the controller 115 as described may be transported to the video decoder 85 for formatting into video signal suitable for display on a monitor (not shown) connected to the video decoder 85. Also, for example, data port 75 may be used to provide high speed data such as computer programs, for example, to a computer. Alternatively, port 75 may be used to output data to an HDTV decoder to display images corresponding to a selected program or a program guide, for example.

Packets that contain PSI information are recognized by unit 45 as destined for the controller 115 buffer in unit 60. The PSI packets are directed to this buffer by unit 65 via units 45, 50 and 55 in a similar manner to that described for packets containing program content. Controller 115 reads the PSI from unit 60 and stores it in internal memory.

Controller 115 also generates condensed PSI (CPSI) from the stored PSI and incorporates the CPSI in a packetized datastream suitable for storage on a selectable storage medium. The packet identification and direction is governed by controller 115 in conjunction with the unit 45 and unit 47 PID, destination and encryption key look-up tables and control unit 65 functions in the manner previously described.

In addition, controller 115 is coupled to a communication interface unit 116 that operates in a manner similar to interface unit 1113 in FIG. 1. That is, unit 116 provides the capability to upload and download information to and from the internet. Communication interface unit 116 includes, for example, a modem for connecting to an internet service provider, e.g., via a telephone line or via a cable television line. The communication capability allows the system shown in FIG. 2 to provide email capability and internet related features such as web browsing in addition to receiving television programming.

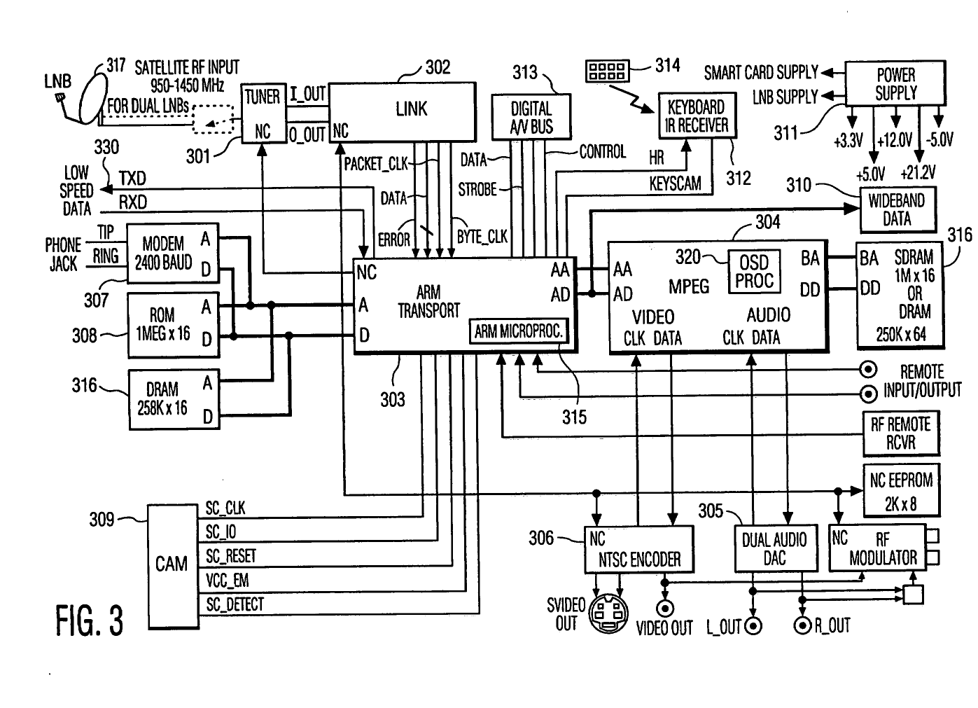

FIG. 3 is a specific implementation of an electronic device generally shown in FIG. 2 and described in detail above. FIG. 3 represents a satellite receiver set-top box, designed and manufactured by Thomson Consumer Electronics, of Indianapolis, Ind., USA, for receiving DIRECTV.™. satellite service provided by Hughes Electronics.

As shown in FIG. 3, the set-top box has a tuner 301 which receives and tunes applicable satellite RF signals in the range of 950-1450 Mhz from a satellite antenna 317. The tuned analog signals are outputted to a link module 302 for further processing. Link module 302 is responsible for further processing of the analog tuned signals I_out and Q_out from tuner 301, including filtering and conditioning of the analog signals, and conversion of the analog signals into a digital output signal, DATA. The link module 302 is implemented as an integrated circuit (IC). The link module IC is manufactured by SGS-Thomson Microelectronics of Grenoble, France, and has Part No. ST 15339-610.

The digital output, DATA, from the link module 302 consists of compliant packetized data stream recognized and processable by the transport unit 303. The data stream, as discussed in detail in relation to FIG. 2, includes program guide data information and the data content of one or more program channels of the satellite broadcast service from DIRECTV.™. As discussed above, program guide data contains information relating to the type of program (e.g., audio-only, video-only, etc.) as indicated, for example, by the “class” type.

The function of the transport unit 303 is the same as the transport system 25 shown in FIG. 2 and discussed already. As described above, the transport unit 303, processes the packetized data stream according to the Packet Identifiers (PID) contained in the header information. The processed data stream is then formatted into MPEG compatible, compressed audio and video packets and coupled to a MPEG decoder 304 for further processing.

The transport unit 303 is controlled by an Advanced RISC Microprocessor (ARM) 315 which is a RISC based microprocessor. The ARM processor 315 executes control software residing in ROM 308. Exemplary components of the software may be, for example, control programs shown in FIGS. 4-5 for processing user interface commands and displaying OSD information in accordance with aspects of the present invention as will be discussed below.

The transport unit 303 is typically implemented as an integrated circuit. For example, a preferred embodiment is an IC manufactured by SGS-Thomson Microelectronics and has a Part No. ST 15273-810 or 15103-65C.

The MPEG compatible, compressed audio and video packets from the transport unit 303 are delivered to a MPEG decoder 304. The MPEG decoder decodes the compressed MPEG datastream from the transport unit 303. The decoder 304 then outputs the applicable audio stream which can be further processed by the audio digital-to-analog converter (DAC) 305 to convert the digital audio data into analog sound. The decoder 304 also outputs applicable digital video data which represents image pixel information to a NTSC encoder 306. The NTSC encoder 306 then further processes this video data into NTSC compatible analog video signal so that video images may be displayed on a regular NTSC television screen. The MPEG decoder as described above may be implemented as an integrated circuit. One exemplary embodiment may be an MPEG decoder IC manufactured by SGS-Thomson Microelectronics having Part No. ST 13520.

Included in the MPEG processor 304 is an OSD processor 320. The OSD processor 320 reads data from SDRAM 316 which contains stored OSD information. OSD information corresponds to bitmap OSD graphics/text images. The OSD processor is capable of varying the color and/or translucency of each pixel of an OSD image under the control of the ARM microprocessor 315 in a conventional manner.

The OSD processor can also be responsible for generating a program guide under the control of the ARM processor 315. In the exemplary embodiment, upon detecting a user request to generate a guide display, the ARM microprocessor 315 processes the program guide data information obtained from a data stream provided by a program guide information provider and formats the guide data information into OSD pixel data corresponding to a “grid guide.” The OSD pixel data from the transport unit 303 is then forwarded to OSD processor 320 in the MPEG audio/video decoder 304 for generating the guide image, as described before.

A low speed data port 330 is used to connect to an IR-Blaster (not shown) for controlling a VCR for recording a program. As discussed before, an IR blaster is basically a programmable VCR remote control emulator controlled by the satellite receiver shown in FIG. 3. It is positioned in front of a VCR remote sensor of an attached VCR and will transmit commands such as “ON” and “RECORD” under the control of the satellite receiver at the appropriate time, according to the timer screen information entered by the users.

Additional relevant functional blocks of FIG. 3 include modem 307 which corresponds to the communication interface unit 116 shown in FIG. 2 for access to the internet, for example. Conditional Access Module (CAM) 309, corresponds to the NRSS decryption unit 130 shown in FIG. 2 for providing conditional access information. Wideband data module 310 corresponds to High Speed Data Port 75 shown in FIG. 2 for providing high speed data access to, for example, a HDTV decoder or a computer. A keyboard/IR Receiver module 312 corresponds to Remote Unit interface 120 shown in FIG. 2 for receiving user control commands from a user control unit 314. Digital AV bus module 313 corresponds to I/O port 100 shown in FIG. 2 for connection to an external device such as a VCR or a DVD player.

FIG. 5 is a high-level flow chart of an exemplary control program which according to the present invention, may be executed by any one of the apparatus shown in FIGS. 1-3, or any other suitably programmed control arrangement of an electronic host device. The term “electronic host device” as used herein is not limited to television receivers or personal computers, but rather encompasses hybrids thereof (e.g., PCTVs), cable television converter boxes, suitably equipped audiovisual program recorders (e.g., VCRs), satellite television and/or data signal converters, program guide receiving units, and the like, regardless of whether incorporated into a television receiver or personal computer or connected externally thereto. It will be appreciated that the process embodied in the exemplary control program may be implemented in hardware, software, or a combination thereof. A person skilled in the art would readily recognize from the flow chart and the following description that the control program when executed by any one of the systems described in FIGS. 1-3 or by other suitably programmed electronic host device will provide substantially the same feature and advantages in accordance with the present invention. Therefore, to avoid redundancy, the control program of FIG. 5 and the user interface of FIG. 4 will be described below only with respect to the exemplary hardware implementation shown in FIG. 2.

Application interface 70, under the control of the system controller 115, generates a new user profile interface as shown in FIG. 4. Preferably, the new user profile interface is generated in response to the new user profile interface being activated (e.g., a system owner activating a particular key on remote control 125 or making a selection in another user interface to create a new user profile). In response to such activation, system controller 115 transfers new user profile interface data to application interface 70. Application interface 70 then outputs the corresponding display information to the video decoder for display on display module 11 (FIG. 4).

Referring to FIG. 4, display module 11 comprising display area 18 having new user profile interface 400 displayed therein is illustrated. System controller 115 monitors the location of a position indicator within new user profile interface 400, such as a cursor and or highlighting. A system owner controls the location of the position indicator using direction and selection keys of remote control 125 as described above. Through use of the position indicator, the system owner can interact with new user profile interface 400, making selection and entering choices into new user profile interface 400 via remote control 125.

New user profile interface 400 is used to create new user profiles according to the present invention. New user profile interface 400 comprises new user name button 401, copy settings button 402, user profile settings buttons 403-406, lock user button 407, and control field 408. When a system owner highlights any of the buttons 401-407, an interactive display corresponding to the highlighted button appears in control field 408. For example, if the system owner highlights new user name button 401, an interactive display having a field for receiving the name of the user for whom the new user profile is being created appears in control field 408. The system owner can then enter the new user's name via commands entered by remote control 125. Similarly, if the system owner highlights any of the user profile settings buttons 403-406, an interactive display will appear in control field 408 having fields for data entry corresponding to the parental control setting associated with that particular button. The system owner can then enter local variables into the fields via remote control 125. The variables entered into the fields by the system owner dictate the parental restraints and limitations for the new user for whom the profile is being created.

However, if the system owner does not feel like selecting each of the user profile setting buttons 403-406 and inputting variables into each field separately, the system owner can highlight copy setting button 402. When copy settings button 402 is highlighted (as illustrated in FIG. 4), an interactive display appears in control field 408 that facilitates the system owner to access user profiles that were previously stored in a non-volatile memory. A list 409 of all previously created and stored user profiles is automatically generated within control field 408. Using remote control 125, the system owner can highlight and select a stored user profile whose settings he or she wishes to copy. Upon highlighting and selecting a stored user profile from list 409, a user can then activate copy button 410. Upon activating copy button 410, the selected user profile is retrieved from the non-volatile memory in which it is stored. Upon locating the selected user profile, data corresponding to the various parental settings established for the stored profile are copied to corresponding data entry fields associated with user profile setting buttons 403-406 (discussed above). As such, a user does not have to fill in each data entry field individually in order to create a new user profile. In other words, the parental restraint settings of the selected user profile are filled in as the local variables in the blank fields of the new user profile.

Optionally, the system owner can then edit any of the copied settings/variables in the same manner as he or she would have entered variables individually as discussed above. The system owner can then save the new user profile to the non-volatile memory.

The “copy settings” feature discussed above allows the system owner to be able to eliminate redundant steps in setting up multiple profiles, by completely setting up one profile and subsequently copying those settings and limits to additional profiles. The system owner could then modify those settings for the new profile based on the age or maturity of the new profile user. For example, the owner of the system could set up profile 1 for use by a 7-year-old child. The limits would most likely be quite strict. He or she could then copy those settings and limits to a new profile 2, which is intended for user by a 10-year-old child. He or she could then relax some of those limits for the older child's profile. The setup time for profile 2 would be considerably less than it would have been had the system owner started with a completely blank profile.

FIG. 5 shows an exemplary flow chart of an exemplary control program which may be executed by system controller 115 of FIG. 2 to implement the features according to aspects of the present invention. Because the process steps of FIG. 5 are explained in the above discussion of FIG. 4, steps 500-530 are not discussed in detail to avoid redundancy.

The foregoing discussion discloses and describes merely exemplary embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A video apparatus comprising:
A) a storage medium having storage locations to store user profiles for users;
B) a user interface for creating new user profiles having fields for data entry to be stored in the storage medium;
C) the user interface for creating new user profiles comprising a user option to select and copy data from a stored user profile; and
D) means to select a stored user profile, copy selected data from the stored user profile to corresponding fields in the new user profile, and save the new user profile at a storage location.

2. The apparatus of claim 1 wherein the data that is copied from the selected stored user profile to the fields of the user interface can be edited.

3. The apparatus of claim 1 wherein the stored user profiles comprise data relating to user identification and one or more of television program rating limits, channel lists, spending limits, viewing hours, and parent or child status.

4. The apparatus of claim 1 wherein the user interface comprises a television screen display and an input module for selecting options presented in the screen display and for entering alphanumeric data in the fields.

5. The apparatus of claim 1 wherein the user interface comprises means for entering data in the fields and making selections

6. The apparatus of claim 1 wherein the means to select a stored user profile, copy selected data from the stored user profile to corresponding fields in the new user profile, and save the new user profile at a storage location comprises a processor agent.

7. The apparatus of claim 1 wherein the user profiles are stored in a non-volatile memory.

8. The apparatus of claim 1 wherein the means to select a stored user profile, copy selected data from the stored user profile to corresponding fields in the new user profile, and save the new user profile at a storage location comprises a processor agent, the user profiles are stored in non-volatile memory, wherein the user interface comprises a television screen display and an input module for selecting options presented in the screen display and for entering alphanumeric data in the fields, and the user profiles comprising user identification and one or more of television program rating limits, channel lists, spending limits, viewing hours, and parent or child status.

9. A television apparatus having a parental control system having a user profile creation apparatus according to claim 1.

10. A method for creating new user profiles in an entertainment apparatus comprising displaying a new user profile interface having means to access a list of stored user profiles, the user profiles comprising data arranged in fields, selecting a stored user profile, and copying data from fields of the selected user profile to corresponding fields of the new user profile interface.

11. The method of claim 10 wherein the fields comprise user identification and one or more of television program rating limits, channel lists, spending limits, viewing hours, and parent or child status.

12. The method of claim 10 comprising saving the new user profile in a non-volatile memory.

13. The method of claim 12 comprising editing the data copied into the fields of the new user profile interface.

14. The method of claim 10 comprising selecting a stored user profile from a non-volatile memory, copying non-volatile memory settings of the selected stored user profile to corresponding local variables of the new user profiles, editing the local variables, and saving the local variables to the non-volatile memory as a new user profile.
